(19) United States
(12) Patent Application Publication
(10) Pub. No.: US 2023/0364786 A1
(43) Pub. Date: Nov. 16, 2023

(54) CONTROL DEVICE, CONTROL METHOD, AND RECORDING MEDIUM

(71) Applicant: NEC Corporation, Minato-ku, Tokyo (JP)

(72) Inventors: Hiroyuki OYAMA, Tokyo (JP); Rin Takano, Tokyo (JP)

(73) Assignee: NEC Corporation, Minato-ku, Tokyo (JP)

(21) Appl. No.: 18/029,325

(22) PCT Filed: Oct. 9, 2020
(86) PCT No.: PCT/JP2020/038296

§ 371 Date: Mar. 29, 2023

(51) Int. Cl. B25J 9/16

(52) U.S. Cl. CPC B25J 9/163; B25J 9/1653; B25J 9/1666

(57) ABSTRACT

A control device 1X mainly includes an abstract state setting means 31X, an environment map generation means 34X, an abstract model generation means 35X, and a control input generation means 36X. The abstract state setting means 31X sets an abstract state which abstractly represents a state of each object in a workspace where each robot works. The environment map generation means 34X generates an environment map which is a map representing accuracy of information in the workspace. The abstract model generation means 35X generates an abstract model which represents dynamics of the abstract state and a time change of the environment map. The control input generation means 36X generates a control input with respect to each robot based on the abstract model.

### TECHNICAL FIELD

The present disclosure relates to a control device, a control method, and a recording medium for controlling an operation of a robot.

### BACKGROUND ART

There is proposed such a control method to perform control of a robot necessary for executing a task when the task to be performed by a robot is given. For example, Patent Document 1 discloses a controller that learns changes in states of an action and an environment, and based on the learned changes, predicts changes in the state of the environment with respect to a predetermined action and plans an action sequence of an autonomous agent from a current state to a target state based on this prediction result.

### PRECEDING TECHNICAL REFERENCES

### Patent Document

Patent Document 1: Japanese Laid-open Patent Publication No. 2007-018490

### SUMMARY

### Problem to be Solved by the Invention

In a case where an operation plan is made to cause a robot perform a given task, an object or the like necessary to be recognized to complete the task may not be measured in an initial state. Even in this case, it is necessary to properly conduct the operation plan and to start the operation of the robot.

It is one object of the present disclosure to provide a control device, a control method, and a recording medium that are capable of suitably control the robot.

### Means for Solving the Problem

According to an example aspect of the present disclosure, there is provided a control device comprising:
an abstract state setting means configured to set an abstract state which abstractly represents a state of each object in a workspace where each robot works;
an environment map generation means configured to generate an environment map which is a map representing accuracy of information in the workspace;
an abstract model generation means configured to generate an abstract model which represents dynamics of the abstract state and a time change of the environment map; and
a control input generation means configured to generate a control input with respect to each robot based on the abstract model.

According to another example aspect of the present disclosure, there is provided control method comprising:
setting an abstract state which abstractly represents a state of each object in a workspace where each robot works;
generating an environment map which is a map representing accuracy of information in the workspace;
generating an abstract model which represents dynamics of the abstract state and a time change of the environment map; and
generating a control input with respect to each robot based on the abstract model.

According to a further example aspect of the present disclosure, there is provided a recording medium storing a program, the program causing a computer to perform a process including:
setting an abstract state which abstractly represents a state of each object in a workspace where each robot works;
generating an environment map which is a map representing accuracy of information in the workspace;
generating an abstract model which represents dynamics of the abstract state and a time change of the environment map; and
generating a control input with respect to each robot based on the abstract model.

### Effect of the Invention

According to the present disclosure, it becomes possible to a control device, a control method, and a recording medium that are capable of suitably control a robot.

### BRIEF DESCRIPTION OF THE DRAWINGS

FIG. 1 illustrates a configuration of a robot control system in a first example embodiment.

FIG. 2A and FIG. 2B respectively illustrate hardware configurations of a robot controller and an instruction device.

FIG. 3 illustrates an example of a data structure of application information.

FIG. 4 illustrates an example of a functional block of the robot controller.

FIG. 5 illustrates a bird's-eye view of a workspace in a case where an objective task is a pick-and-place.

FIG. 6 illustrates a bird's-eye view of the workspace of a robot in a case where the robot is a mobile body.

FIG. 7 is a bird's-eye view of the workspace which schematically represents a relationship between an unmeasured space in the initial state and a measured space.

FIG. 8 is a bird's-eye view of the workspace which schematically represents a relationship between the unmeasured space after the robot moves and the measured space.

FIG. 9 illustrates an example of a flowchart for explaining schematically a robot control process which the robot controller executes in the first example embodiment.

FIG. 10 is a diagram illustrating a schematic configuration of a control device in a second example embodiment.

FIG. 11 illustrates an example of a flowchart executed by the control device in the second example embodiment.

### EXAMPLE EMBODIMENTS

In the following, example embodiments will be described with reference to the accompanying drawings.

### First Example Embodiment

(1) System Configuration

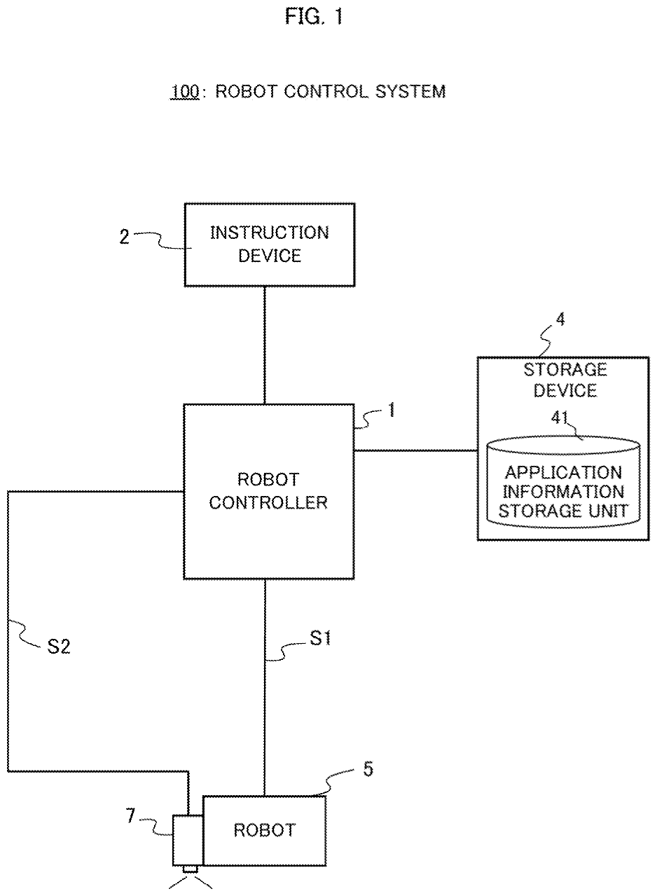

FIG. 1 illustrates a configuration of a robot control system 100 according to a first example embodiment. The robot control system 100 mainly includes a robot controller 1, an instruction device 2, a storage device 4, a robot 5, and a measurement device 7.

In a case where a task to be executed by the robot 5 (also referred to as an “objective task”) is specified, the robot controller 1 converts the objective task into a sequence for each time step of a simple task which the robot 5 can accept, and controls the robot 5 based on the generated sequence.

In addition, the robot controller 1 performs data communications with the instruction device 2, the storage device 4, the robot 5, and the measurement device 7 through a communication network or direct communications by a wireless or wired channel. For instance, the robot controller 1 receives an input signal related to a designation of the objective task, generation, update of application information, or the like from the instruction device 2. Moreover, with respect to the instruction device 2, the robot controller 1 executes a predetermined display or a sound output to the instruction device 2 by transmitting a predetermined output control signal. Furthermore, the robot controller 1 transmits a control signal “S1” related to the control of the robot 5 to the robot 5. Also, the robot controller 1 receives a measurement signal “S2” from the measurement device 7.

The instruction device 2 is a device for receiving an instruction to the robot 5 by an operator. The instruction device 2 performs a predetermined display or sound output based on the output control signal supplied from the robot controller 1, or supplies the input signal generated based on an input of the operator to the robot controller 1. The instruction device 2 may be a tablet terminal including an input section and a display section, or may be a stationary personal computer.

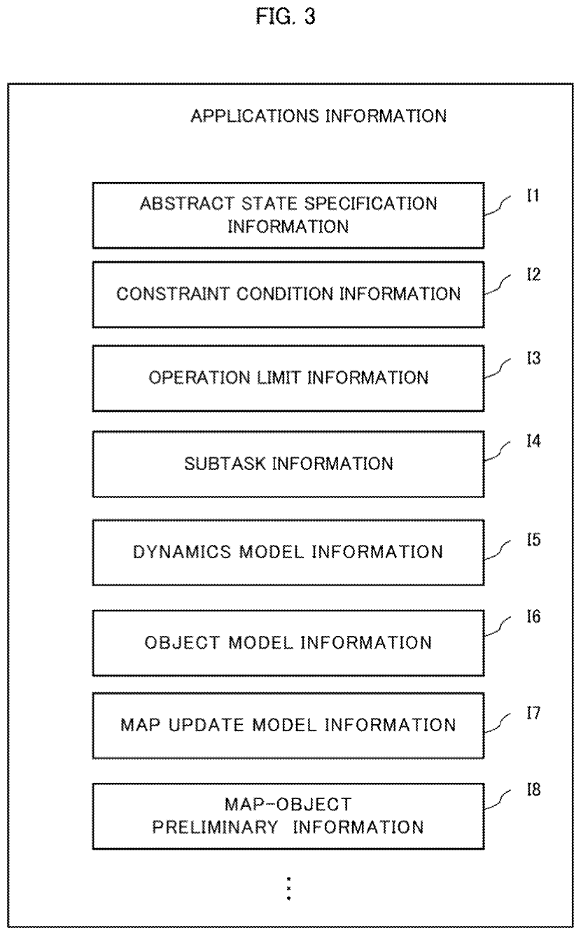

The storage device 4 includes an application information storage unit 41. The application information storage unit 41 stores application information necessary for generating an operation sequence which is a sequence of operations to be executed by the robot 5, from the objective task. Details of the application information will be described later with reference to FIG. 3. The storage device 4 may be an external storage device such as a hard disk connected or built into the robot controller 1, or may be a storage medium such as a flash memory. The storage device 4 may be a server device which performs data communications with the robot controller 1 via the communication network. In this case, the storage device 4 may be formed by a plurality of server devices.

The robot 5 performs a work related to the objective task based on the control signal S1 supplied from the robot controller 1. The robot 5 corresponds to, for instance, a robot that operates in various factories such as an assembly factory and a food factory, or a logistics site. The robot 5 may be a vertical articulated robot, a horizontal articulated robot, or any other type of robot. The robot 5 may supply a state signal indicating a state of the robot 5 to the robot controller 1. The state signal may be an output signal from a sensor (internal sensor) for detecting a state (such as a position, an angle, or the like) of the entire robot 5 or of specific portions such as joints of the robot 5, or may be a signal which indicates a progress of the sequence of an operation plan of the robot 5 which is represented by the control signal S1.

The measurement device 7 is one or more sensors (external sensors) formed by a camera, a range sensor, a sonar, or a combination thereof to detect a state in a workspace in which the objective task is performed. The measurement device 7 may include sensors provided in the robot 5 and may include sensors provided in the workspace. In the former case, the measurement device 7 includes an external sensor such as a camera provided in the robot 5, and the measurement range is changed in accordance with the operation of the robot 5. In other examples, the measurement device 7 may include a self-propelled sensor or a flying sensor (including a drone) which moves in the workspace of the robot 5. Moreover, the measurement device 7 may also include a sensor which detects a sound or a tactile sensation of an object in the workspace. Accordingly, the measurement device 7 may include a variety of sensors that detect conditions in the workspace, and may include sensors located anywhere.

Note that the configuration of the robot control system 100 illustrated in FIG. 1 is an example, and various changes may be made to the configuration. For instance, a plurality of the robots 5 may exist, and the robot 5 may be equipped with a plurality of control targets which operate independently such as robot arms. Even in these cases, the robot controller 1 transmits the control signal S1 representing a sequence which defines the operation for each robot 5 or for each control target to the robot 5 to be controlled based on the objective task. Furthermore, the robot 5 may be one that performs a cooperative work with other robots, the operator, or machine tools which operate in the workspace. Moreover, the measurement device 7 may be a part of the robot 5. The instruction device 2 may be formed as the same device as the robot controller 1. In addition, the robot controller 1 may be formed by a plurality of devices. In this case, the plurality of devices forming the robot controller 1 exchanges information necessary to execute a process assigned in advance among these devices. Moreover, the robot controller 1 and the robot 5 may be integrally formed.

(2) Hardware Configuration

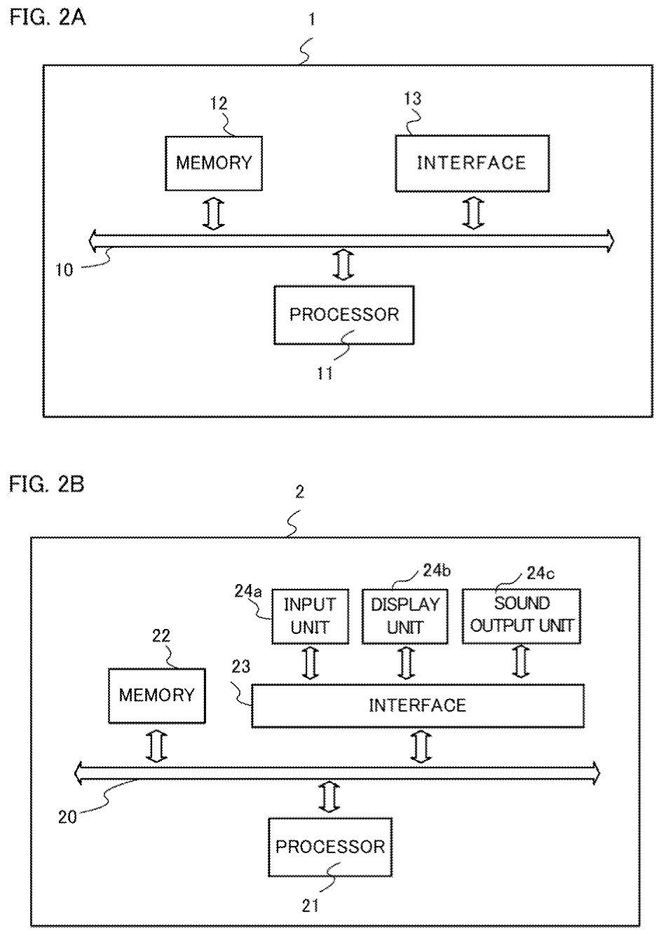

FIG. 2A illustrates a hardware configuration of the robot controller 1. The robot controller 1 includes a processor 11, a memory 12, and an interface 13 as hardware. The processor 11, the memory 12, and the interface 13 are connected via a data bus 10.

The processor 11 functions as a controller (arithmetic unit) for performing an overall control of the robot controller 1 by executing programs stored in the memory 12. The processor 11 is, for instance, a CPU (Central Processing Unit), a GPU (Graphics Processing Unit), a TPU (Tensor Processing Unit) or the like. The processor 11 may be formed by a plurality of processors. The processor 11 is an example of a computer.

The memory 12 includes various volatile and non-transitory memories such as a RAM (Random Access Memory), a ROM (Read Only Memory), a flash memory, and the like. In addition, programs executed by the robot controller 1 are stored in the memory 12. A part of information stored in the memory 12 may be stored by one or a plurality of external storage devices capable of communicating with the robot controller 1, or may be stored in a recording medium detachable from the robot controller 1.

The interface 13 is an interface for electrically connecting the robot controller 1 and other devices. These interfaces may be wireless interfaces such as network adapters or the like for transmitting and receiving data to and from other devices wirelessly, or may be hardware interfaces for connecting the other devices by as cables or the like.

Note that the hardware configuration of the robot controller 1 is not limited to the configuration illustrated in FIG. 2A. For instance, the robot controller 1 may be connected to or built in at least one of a display device, an input device, and the sound output device. The robot controller 1 may be configured to include at least one of the instruction device 2 and the storage device 4.

FIG. 2B illustrates a hardware configuration of the instruction device 2. The instruction device 2 includes, as hardware, a processor 21, a memory 22, an interface 23, an input unit 24a, a display unit 24b, and a sound output unit 24c. The processor 21, the memory 22 and the interface 23 are connected via a data bus 20. Moreover, the input unit 24a, the display unit 24b, the sound output unit 24c, are connected to the interface 23.

The processor 21 executes a predetermined process by executing a program stored in the memory 22. The processor 21 is a processor such as a CPU, a GPU, or the like. The processor 21 receives a signal generated by the input unit 24a via the interface 23, generates the input signal, and transmits the input signal to the robot controller 1 via the interface 23. Moreover, the processor 21 controls at least one of the display unit 24b and the sound output unit 24c via the interface 23 based on the output control signal received from the robot controller 1.

The memory 22 is formed by various volatile memories and various non-transitory memories such as a RAM, a ROM, a flash memory, and the like. Moreover, programs for executing processes executed by the instruction device 2 are stored in the memory 22.

The interface 23 is an interface for electrically connecting the instruction device 2 with other devices. These interfaces may be wireless interfaces such as network adapters or the like for transmitting and receiving data to and from other devices wirelessly, or may be hardware interfaces for connecting the other devices by cables or the like. Moreover, the interface 23 performs interface operations of the input unit 24a, the display unit 24b, and the sound output unit 24c. The input unit 24a is an interface that receives input from a user, and corresponds to, for instance, each of a touch panel, a button, a keyboard, and a voice input device. The display unit 24b corresponds to, for instance, a display, a projector, or the like, and displays screens based on the control of the processor 21. The sound output unit 24c corresponds to, for instance, a speaker, and outputs sounds based on the control of the processor 21.

The hardware configuration of the instruction device 2 is not limited to the configuration depicted in FIG. 2B. For instance, at least one of the input unit 24a, the display unit 24b, and the sound output unit 24c may be formed as a separate device that electrically connects to the instruction device 2. Moreover, the instruction device 2 may also be connected to various devices such as a camera and the like, and may incorporate them.

(3) Application Information

Next, a data structure of the application information stored in the application information storage unit 41 will be described.

FIG. 3 illustrates an example of a data structure of the application information. As illustrated in FIG. 3, the application information includes abstract state specification information I1, constraint condition information I2, operation limit information I3, subtask information I4, dynamics model information I5, object model information I6, a map update model information I7, and a map-object preliminary information I8.

The abstract state specification information I1 is information that specifies an abstract state necessary to be defined for a generation of the operation sequence. This abstract state abstractly represents a state of the object in the workspace and is defined as a proposition to be used in a target logical formula described below. For instance, the abstract state specification information I1 specifies the abstract state to be defined for each type of the objective task.

The constraint condition information I2 indicates the constraint conditions for executing the objective task. The constraint condition information I2 indicates, for instance, a constraint condition that a contact from the robot (robot arm) to an obstacle is restricted or a constraint condition that a contact between the robots 5 (robot arms) is restricted in a case where the objective task is a pick-and-place, and or other constraint conditions. The constraint condition information I2 may be information in which appropriate constraint conditions are recorded for respective types of the objective tasks.

The operation limit information I3 indicates information concerning an operation limit of the robot 5 to be controlled by the robot controller 1. The operation limit information I3 is, for instance, information defining an upper limit of a speed, an acceleration, or an angular velocity of the robot 5. It is noted that the operation limit information I3 may be information defining an operation limit for each movable portion or each joint of the robot 5.

The subtask information I4 indicates information on subtasks to be components of the operation sequence. The “subtask” is a task in which the objective task is decomposed by a unit which can be accepted by the robot 5, and refers to each subdivided operation of the robot 5. For instance, in a case where the objective task is the pick-and-place, the subtask information I4 defines, as subtasks, a subtask “reaching” that is a movement of the robot arm of the robot 5, and a subtask “grasping” that is the grasping by the robot arm. The subtask information I4 may indicate information of the subtasks that can be used for each type of the objective task.

The dynamics model information I5 is information concerning a dynamics model abstracting dynamics in the workspace. For instance, the dynamics model may be a model that abstracts real dynamics by a hybrid system. In this instance, the dynamics model information I5 includes information indicating a switch condition of the dynamics in the hybrid system described above. For instance, in a case of the pick-and-place in which the robot 5 grabs and moves an object to be worked (also referred to as a “target object”) to a predetermined position by the robot 5, the switch condition corresponds to a condition in which the target object cannot be moved unless the target object is gripped by the robot 5. The dynamics model information I5 includes information concerning the dynamics model suitable for each type of the objective task.

The object model information I6 is information concerning an object model of each object in the workspace to be recognized from the measurement signal S2 generated by the measurement device 7. Examples of the above-described each object include the robot 5, an obstacle, a tool and any other target object handled by the robot 5, a working body other than the robot 5. The object model information I6 includes, for instance, information necessary for the control device 1 to recognize a type, a position, a posture, a currently executed operation, and the like of each object described above, and three-dimensional shape information such as CAD (Computer Aided Design) data for recognizing a three-dimensional shape of each object. The former information includes parameters of an inference engine which are acquired by learning a training model in a machine learning such as a neural network. For instance, the above-mentioned inference engine is trained in advance to output the type, the position, the posture, and the like of each object to be a subject in the image when an image is inputted to the inference engine. Moreover, in a case where an AR marker for an image recognition is attached to a main object such as the target object, information necessary for recognizing the object by the AR marker may be stored as the object model information I6.

The map update model information I7 is information concerning the model which updates a map (also called an “environment map b”) which represents an accuracy of information collected in the workspace (environment) of the robot 5 (also called a “map update model V”).

The environment map b is generated by the robot controller 1. The environment map b may be, for instance, information which discretely represents the accuracy of information for each grid in a case of dividing a target space (two-dimensional or three-dimensional space) into grids, and may be information which continuously represents the accuracy of information in the target space.

Alternatively, the environment map b may be information of the accuracy represented in a space in which an axis representing a concept such as time or the like is added to an axis of a physical two-dimensional or three-dimensional space. Also, the environment map b may have a temporal decay in accuracy. For instance, in such a case where the measurement device 7 is a mobile robot for searching a maze or the like, a state may change over time even at a place where the measurement is taken, and the accuracy of the information decreases with the lapse of time after the measurement. Taking the above into consideration, the robot controller 1 may update the environment map b so that the accuracy represented by the environment map b is attenuated as time passes after the measurement.

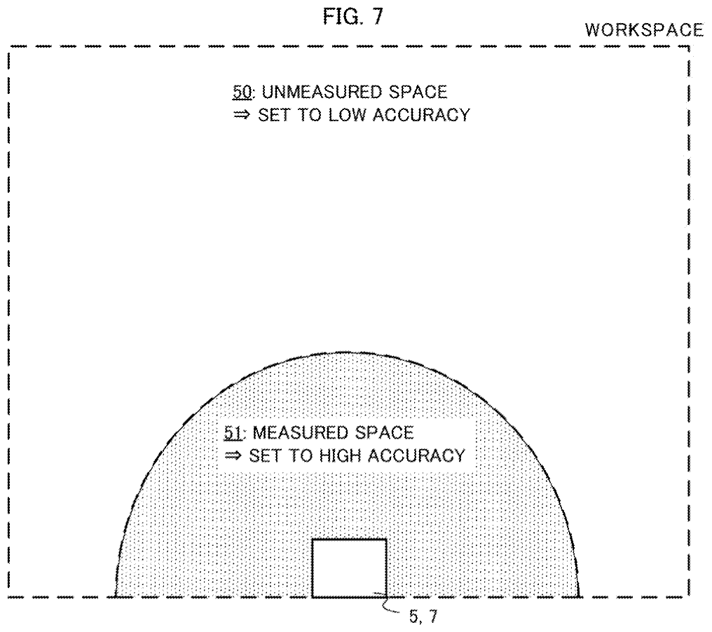

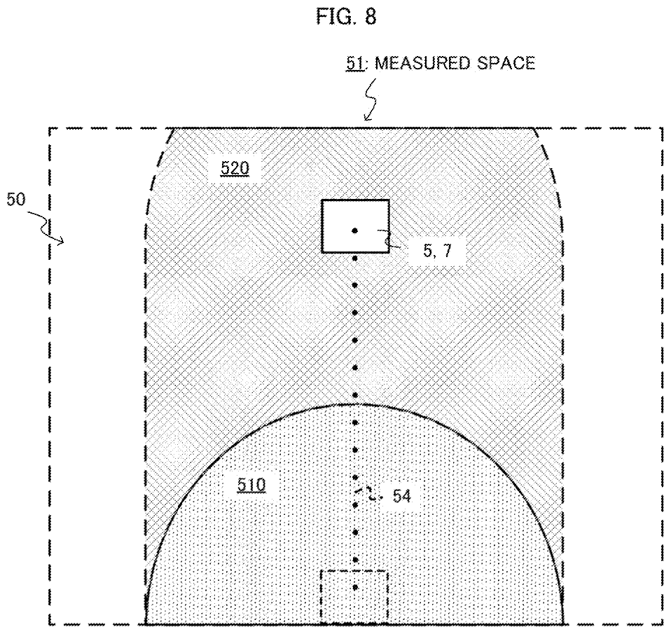

The map update model b⁺ is a model for predicting the time change of the environment map b, and is, for instance, represented by a function in which arguments are a predicted input to the robot 5, an abstract state being set, and the current environment map b. For instance, the map update model b⁺ is generated in advance in consideration of an installation position, an installation orientation (angle), a viewing angle of the measurement device 7, a measurable distance, and the like of the measurement device 7 installed on the robot 5. The environment map b and the map update model b⁺ will be described in detail with reference to FIG. 7 and FIG. 8, which will be described later.

The map-object preliminary information I8 represents preliminary information concerning the object for which the environment map b and the abstract state are to be set. The map-object preliminary information I8 may be information generated before the robot controller 1 performs the operation plan of the robot 5, and may include, for instance, information representing the initial state of any object and may include information representing an initial state of the environment map b. The map update model information I7 and the map-object preliminary information I8 may be information generated based on external input by the user using the instruction device 2.

Note that in addition to the information described above, the application information storage unit 41 may store various information necessary for the robot controller 1 to generate the control signal S1. For instance, the application information storage unit 41 may store information which specifies the workspace of the robot 5.

(4) Process Overview

Next, an outline of the process by the robot controller 1 will be described. Schematically, the robot controller 1 uses the environment map b and the map update model b⁺ to perform the operation plan of the robot 5 considering the uncertainty of the environment. Subsequently, while the robot 5 is operating based on the control signal S1, the robot controller 1 updates the environment map b based on the measurement signal S2, and performs resetting of the abstract model and re-generating of the control signal S1 in accordance with changes in the abstract state. Accordingly, the robot controller 1 suitably controls the robot 5 so as to complete the objective task even in the environment with the uncertainty.

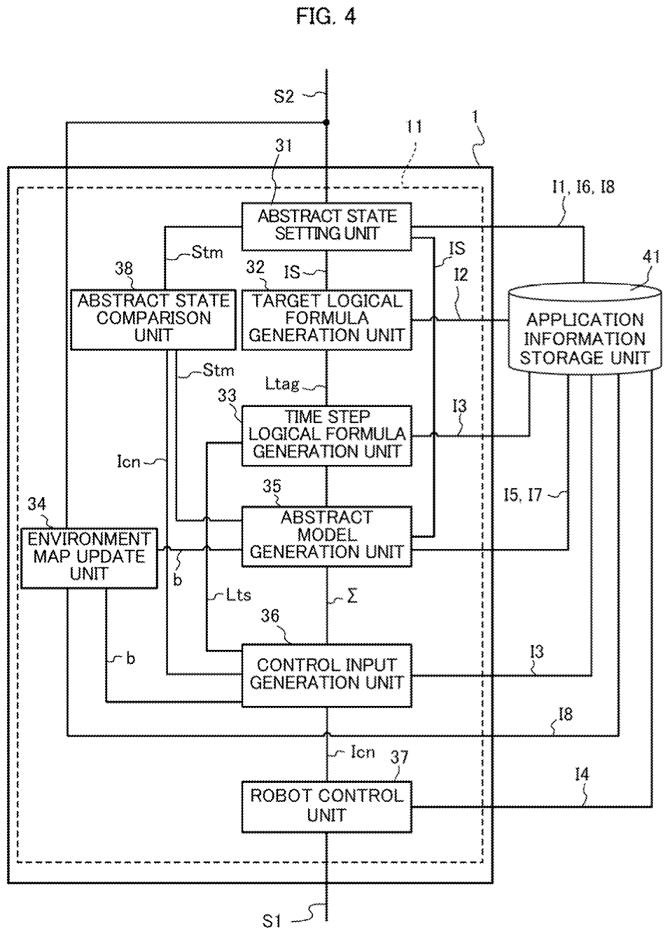

FIG. 4 is an example of a functional block illustrating an outline of the process executed by the robot controller 1. The processor 11 of the robot controller 1 functionally includes an abstract state setting unit 31, a target logical formula generation unit 32, a time step logical formula generation unit 33, an environment map update unit 34, an abstract model generation unit 35, a control input generation unit 36, a robot control unit 37, and an abstract state comparison unit 38. In FIG. 4, an example of data to be transmitted and received between the blocks is illustrated, but is not limited thereto. The same applies to diagrams illustrating other functional blocks described below.

The abstract state setting unit 31 sets the abstract state in the workspace based on the measurement signal S2 supplied from the measurement device 7, the abstract state specification information I1, and the object model information I6. In this case, when the measurement signal S2 is received, the abstract state setting unit 31 refers to the object model information I6 or the like, and recognizes an attribute such as the type or the like, the position, and the posture, and the like of each object in the workspace which are necessary to be considered at a time of executing the objective task. A recognition result of the state is represented, for instance, as a state vector. The abstract state setting unit 31 defines a proposition for representing each abstract state in a logical formula, which is necessary considered at a time of executing the objective task, based on the recognition result for each object. The abstract state setting unit 31 supplies information indicating the set abstract state (also referred to as “abstract state setting information IS”) to the target logical formula generation unit 32.

Moreover, the abstract state setting unit 31 recognizes the latest abstract state of each object in the workspace based on the most recent measurement signal S2 at every predetermined time interval (for instance, every predetermined time step) in a period (also referred to as a “robot operation period Tw”) in which the robot 5 is operating based on the control signal S1. After that, the abstract state setting unit 31 supplies information representing the abstract state (also referred to as a “measurement abstract state Stm”) which recognized based on the most recent measurement signal S2 to the abstract state comparison unit 38.

Based on the abstract state setting information IS, the target logical formula generation unit 32 converts the specified objective task into a logical formula of a temporal logic (also called a “target logical formula Ltag”) representing a final achievement state. In this case, the target logical formula generation unit 32 refers to the constraint condition information I2 from the application information storage unit 41, and adds the constraint condition to be satisfied in the execution of the target logical formula Ltag. Then, the target logical formula generation unit 32 supplies the generated target logical formula Ltag to the time step logical formula generation unit 33.

The time step logical formula generation unit 33 converts the target logical formula Ltag supplied from the target logical formula generation unit 32 into the logical formula (also referred to as a “time step logical formula Lts”) representing the state at each of time steps. The time step logical formula generation unit 33 supplies the generated time step logical formula Lts to the control input generation unit 36.

The environment map update unit 34 generates the environment map b to be the initial condition based on the map-object preliminary information I8 and the measurement signal S2 at the time of the operation plan before the robot 5 operates. Moreover, in the robot operation period Tw, the environment map update unit 34 updates the environment map b based on the measurement signal S2 at the predetermined time interval (for instance, each predetermined time step). The environment map update unit 34 supplies the generated or updated environment map b to the abstract model generation unit 35 and the control input generation unit 36. Note that the map-object preliminary information I8 may not exist. In this instance, the environment map update unit 34 generates the environment map b representing the accuracy of the information in the initial condition of the workspace based on the measurement signal S2. In other words, the environment map update unit 34 may update the environment map b so as to attenuate the accuracy in the space measured by the measurement device 7 according to the passage of time after the measurement.

Based on the dynamics model information I5, the map update model information I7, and the abstract state setting information IS, the abstract model generation unit 35 generates an abstract model “Σ” including the dynamics model abstracting the actual dynamics in the workspace and a map update model b⁺. The method for generating the abstract model Σ will be described later. The abstract model generation unit 35 supplies the generated abstract model Σ to the control input generation unit 36.

The control input generation unit 36 determines the control input to the robot 5 for each of the time steps to satisfy the time step logical formula Lts supplied from the time step logical formula generation unit 33 and the abstract model Σ supplied from the abstract model generation unit 35 and to optimize an evaluation function. Next, the control input generation unit 36 supplies information (also referred to as “control input information Icn”) related to the control input for each time step to the robot 5, to the robot control unit 37 and the abstract state comparison unit 38.

The robot control unit 37 generates the control signal S1 representing the sequence of subtasks which is interpretable for the robot 5 based on the control input information Icn supplied from the control input generation unit 36 and the subtask information I4 stored in the application information storage unit 41. Next, the robot control unit 37 supplies the control signal S1 to the robot 5 through the interface 13. Note that the robot 5 may include a function corresponding to the robot control unit 37 in place of the robot controller 1. In this instance, the robot 5 executes an operation for each planned time step based on the control input information Icn supplied from the robot controller 1.

The abstract state comparison unit 38 determines whether or not the re-generation of the abstract model Σ is necessary based on the change of the abstract state during the robot operation period Tw. In this instance, the abstract state comparison unit 38 compares the measurement abstract state Stm (that is, the measured current abstract state) supplied from the abstract state setting unit 31 with a current abstract state (also referred to as a “prediction abstract state Stp”) which is predicted based on the control input information Icn. Next, when it is determined that there is a substantial difference between the measurement abstract state Stm and the prediction abstract state Stp, the abstract state comparison unit 38 determines that the abstract model Σ needs to be re-produced, and supplies the measurement abstract state Stm to the abstract model generation unit 35.

Here, each of components of the abstract state setting unit 31, the target logical formula generation unit 32, the time step logical formula generation unit 33, the environment map update unit 34, the abstract model generation unit 35, the control input generation unit 36, the robot control unit 37, and the abstract state comparison unit 38 can be realized, for instance, by the processor 11 executing a corresponding program. Moreover, the necessary programs may be recorded on any non-volatile storage medium and installed as necessary to realize each of the components. Note that at least a portion of each of these components may be implemented by any combination of hardware, firmware, and software, or the like, without being limited to being implemented by the software based on the program. At least some of these components may also be implemented using a user programmable integrated circuitry such as, for instance, an FPGA (Field-Programmable Gate Array) or a microcontroller. In this case, the integrated circuit may be used to realize the program formed by each of the above components. At least some of the components may also be comprised of an ASSP (Application Specific Standard Produce), an ASIC (Application Specific Integrated Circuit), or a quantum computer control chip. Thus, each component may be implemented by various hardware. The above is the same in other example embodiments described later. Furthermore, each of these components may be implemented by cooperation of a plurality of computers, for instance, using a cloud computing technology.

(5) Details of Each Process Unit

Next, details of a process performed by each process unit described in FIG. 4 will be described in order.

(5-1) Abstract State Setting Unit

First, the abstract state setting unit 31 refers to the object model information I6 and analyzes the measurement signal S2 by a technique (a technique using an image processing technique, an image recognition technique, a speech recognition technique, an RFID (Radio Frequency Identifier) or the like which recognizes the environment of the workspace, thereby recognizing the state and the attribute (type or the like) of each object existing in the workspace. As the image recognition technique described above, there are a semantic segmentation based on a deep learning, a model matching, a recognition using an AR marker, and the like. The above recognition result includes information such as the type, the position, and the posture of each object in the workspace. The object in the workspace is, for instance, the robot 5, a target object such as a tool or a part handled by the robot 5, an obstacle and another working body (a person or another object performing a work other than the robot 5), or the like.

Next, the abstract state setting unit 31 sets the abstract state in the workspace based on the recognition result of the object by the measurement signal S2 or the like and the abstract state specification information I1 acquired from the application information storage unit 41. In this case, first, the abstract state setting unit 31 refers to the abstract state specification information I1, and recognizes the abstract state to be set in the workspace. Note that the abstract state to be set in the workspace differs depending on the type of the objective task. Therefore, in a case where the abstract state to be set for each type of the objective task is specified in the abstract state specification information I1, the abstract state setting unit 31 refers to the abstract state specification information I1 corresponding to the specified objective task and recognizes the abstract state to be set.

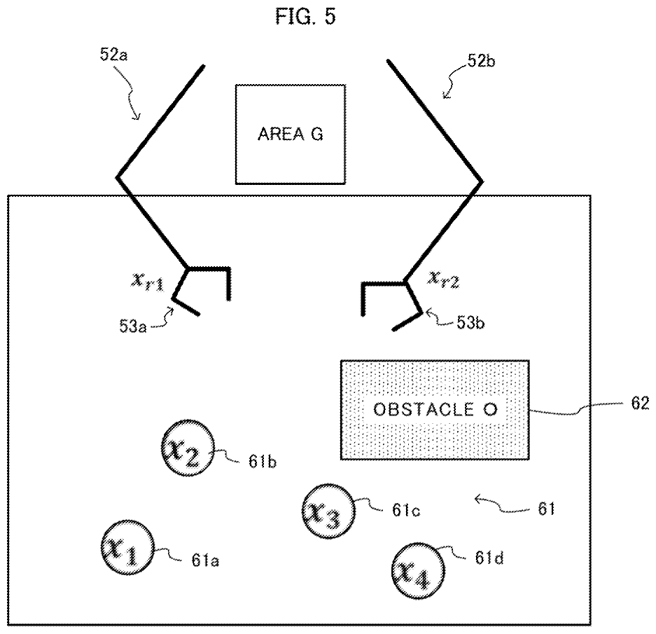

FIG. 5 illustrates a bird's-eye view of the workspace in a case of using the pick-and-place as the objective task. In the workspace illustrated in FIG. 5, there are two robot arms 52a and 52b, four target objects 61 (61a to 61d), an obstacle 62, and an area G which is the destination of the target objects 61.

In this case, first, the abstract state setting unit 31 recognizes the state of each object in the workspace. In detail, the abstract state setting unit 31 recognizes the state of the target objects 61, the state (here, an existence range or the like) of the obstacle 62, the state of the robot 5, the state of the area G (here, the existence range or the like), and the like.

Here, the abstract state setting unit 31 recognizes position vectors “x₁” to “x₄” of centers of the target objects 61a to 61d as the positions of the target objects 61a to 61d. Moreover, the abstract state setting unit 31 recognizes a position vector “xᵣ₁” of a robot hand 53a for grasping the target object and a position vector “xᵣ₂” of a robot hand 53b respectively as positions of the robot arm 52a and the robot arm 52b. Note that these position vectors x₁ to x₄, xᵣ₁, and xᵣ₂ may be defined as state vectors including various elements concerning the states such as elements related to the postures (angles), elements related to speed, and the like of the corresponding objects.

Similarly, the abstract state setting unit 31 recognizes the existence range of the obstacle 62, the existence range of the area G, and the like. Note that for instance, in a case of regarding the obstacle 62 as a rectangular parallelepiped and the area G as a rectangle, the abstract state setting unit 31 recognizes position vectors respective to vertexes of the obstacle 62 and the area G.

The abstract state setting unit 31 determines the abstract state to be defined in the objective task by referring to the abstract state specification information I1. In this instance, the abstract state setting unit 31 determines a proposition indicating the abstract state based on the recognition result concerning an object existing in the workspace (for instance, the number of objects for each type) and the abstract state specification information I1.

In the example in FIG. 5, the abstract state setting unit 31 adds the identification labels “1” to “4” to the target objects 61a to 61d recognized based on the measurement signal S2 and the like. In addition, the abstract state setting unit 31 defines a proposition “gᵢ” that target objects “i” (i=1 to 4) exist in the area G which is a target point to be finally placed. Moreover, the abstract state setting unit 31 applies an identification label “O” to the obstacle 62, and defines a proposition “oᵢ” that the target object i is interfering with the obstacle O. Furthermore, the abstract state setting unit 31 defines a proposition “h” that the robot arms 52 interfere with each other.

As described above, the abstract state setting unit 31 recognizes abstract states to be defined by referring to the abstract state designation information I1, and defines propositions (in the above-described example, gᵢ, oᵢ, h, and the like) representing the abstract state in accordance with the number of the target objects 61, the number of the robot arms 52, the number of the obstacles 62, the number of the robots 5, and the like. Next, the abstract state setting unit 31 supplies information representing the set abstract states (including the propositions and the state vectors representing the abstract states) as the abstract state setting information IS to the target logical formula generation unit 32.

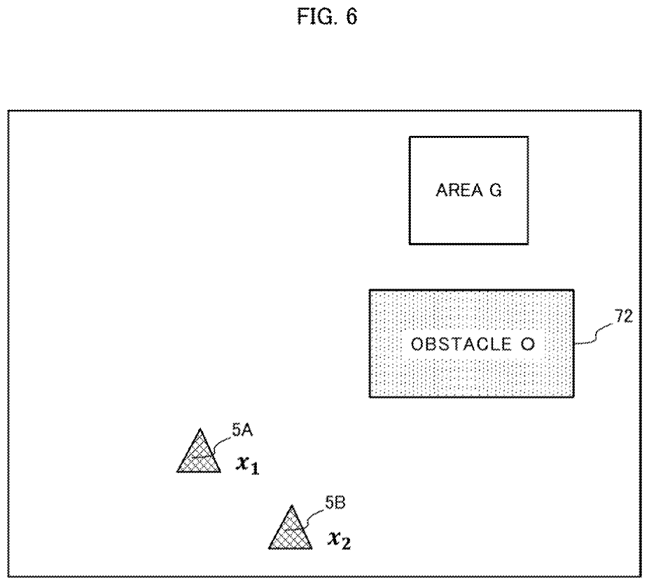

FIG. 6 illustrates a bird's-eye view of the workspace (operation range) of the robot 5 in a case where the robot 5 is a mobile body. In the workspace illustrated in FIG. 6, there are two robots 5A and 5B, an obstacle 72, and the area G, which is the destination of the robots 5A and 5B.

In this case, first, the abstract state setting unit 31 recognizes the state of each object in the workspace. In detail, the abstract state setting unit 31 recognizes the positions, the postures and the moving speeds of the robots 5A and 5B, the existence regions of the obstacle 72 and the area G, and the like. Next, the abstract state setting unit 31 sets a state vector “x₁” representing the position and the posture (and the moving speed) of the robot 5A, and a state vector “x₂” representing the position, the posture (and the moving speed) of the robot 5B, respectively. Moreover, the abstract state setting unit 31 represents the robots 5A and 5B by robots “i” (i=1 to 2), and defines the propositions “gᵢ” that the robots i exist in the area G which is the target point to be finally placed. In addition, the abstract state setting unit 31 adds an identification label “O” to the obstacle 72, defines the proposition “oᵢ” that the robot i is interfering with the obstacle O. Furthermore, the abstract state setting unit 31 defines the proposition “h” that the robots i interfere with each other.

Accordingly, the abstract state setting unit 31 recognizes the abstract state to be defined even in a case where the robot 5 is the mobile body, and can suitably set the propositions (gᵢ, oᵢ, h, and the like in the above-described cases) representing the abstract states. Next, the abstract state setting unit 31 supplies information indicating the propositions representing the abstract state to the target logical formula generation unit 32 as the abstract state setting information IS.

Note that the task to be set may be a case in which the robot 5 moves and performs the pick-and-place (that is, the task corresponds to a combination of the examples of FIG. 5 and FIG. 6). Even in this case the abstract state setting unit 31 generates the abstract state setting information IS representing the abstract states and the propositions representing the abstract states which encompass both the examples in FIG. 5 and FIG. 6.

Here, a case will be described in which there is an object (also referred to as an unset object.) to which the abstract state cannot be set because the measurement device 7 cannot measure the abstract state, among the objects (including an area such as the area G) to set the abstract states. The object for which the abstract state is to be set is an object designated as an object for which the abstract state is to be set, for instance, in the abstract state specification information I1. The unset object may be an object to be worked by the robot 5, or may be an object or a goal point of the robot 5 (the area G in FIG. 5 or FIG. 6).

In this case, the abstract state setting unit 31 defines the proposition regarding the unset object while the state vector representing the position or the like of the unset object is undetermined. For instance, in the example in FIG. 6, in a case where the area G is not be measured by the measurement signal S2 because the area G exists in the blind spot of the measurement device 7 due to the obstacle 72, the abstract state setting unit 31 sets the propositions (that is, gᵢ and the like) related to the area G while leaving the abstract state of the area G unset (that is, while leaving a value of the state vector representing the state undetermined).

Note that, the unset object may be an object which exists farther than a measurable distance of the measurement device 7, or an object which is accommodated in a housing or the like, other than the object existing in the blind spot formed by the obstacle. For instance, in a case where the objective task which needs an operation of taking the target object out of a box is set, the target object cannot be measured by the measurement device 7 until a lid of the box is opened. In this instance, the target object is handled as the unset object until the robot 5 opens the lid of the box until the robot controller 1 recognizes the target object based on the measurement signal S2.

In a case where the position or the like of the object is specified in advance in the map-object preliminary information I8, the abstract state setting unit 31 may set the abstract state (state vector) of the object that is unable to be measured by the measurement device 7 based on the map-object preliminary information I8.

Accordingly, even in a case where the object necessary for performing the objective task is unable to be measured in the initial state (that is, the stage of the operation plan), it is possible for the abstract state setting unit 31 to suitably determine the proposition necessary for formulating the operation plan of the robot 5.

(5-2) Target Logical Formula Generation Unit

Hereafter, the target logical formula Ltag will be described in a case where the environment map b is not considered.

For instance, in the example of the pick-and-place illustrated in FIG. 5, suppose that the objective task of “finally all target objects are present in the area G” is provided. In this case, the target logical formula generation unit 32 generates the following logical formula representing a goal state of the objective task using an operator “⋄” corresponding to “eventually” of a linear logical formula (LTL: Linear Temporal Logic), an operator “□” corresponding to “always”, and a proposition “gᵢ” defined by the abstract state setting unit 31.

∧ᵢ⋄□gᵢ

Note that the target logical formula generation unit 32 may express the logical formula using operators of any temporal logic other than the operators “⋄” and “□” (that is, a logical product “∧”, a logical sum “∧”, a negative “¬” a logical inclusion “⇒”, a next “◯”, a until “U”, and the like). Moreover, it is not limited to a linear temporal logic, and the logical formula corresponding to the objective task may be expressed using any temporal logic such as an MTL (Metric Temporal Logic) or an STL (Signal Temporal Logic).

Next, the target logical formula generation unit 32 generates the target logical formula Ltag by adding the constraint condition indicated by the constraint condition information I2 to the logical formula representing the objective task.

For instance, in a case where as constraint conditions corresponding to the pick-and-place illustrated in FIG. 5, two constraint conditions are included in the constraint condition information I2; “the robot arms 52 always do not interfere with each other” and “the target object i always does not interfere with the obstacle O”, the target logical formula generation unit 32 converts these constraint conditions into the logical formulae. In detail, the target logical formula generation unit 32 converts the above-described two constraint conditions into the following logical formulae, respectively, using the proposition “oᵢ” and the proposition “h” defined by the abstract state setting unit 31.

□¬h

∧ᵢ□¬oᵢ

Therefore, in this case, the target logical formula generation unit 32 adds the logical formulae of these constraint conditions to the logical formula “∧ᵢ⋄gᵢ” corresponding to the objective task that “finally all objects are present in the area G”, and generates the following target logical formula Ltag.

(∧ᵢ⋄□gᵢ)∧(∧¬h)∧(∧ᵢ□¬oᵢ)

In practice, the constraint conditions corresponding to the pick-and-place are not limited to the two described above constraint conditions, and constraint conditions exist such as “the robot arm 52 does not interfere with the obstacle O,” “the plurality of robot arms 52 do not grab the same target object,” and “the target objects do not contact with each other”. Similarly, these constraint conditions are stored in the constraint condition information I2 and reflected in the target logical formula Ltag.

Next, an example illustrated in FIG. 6 will be described in a case where the robot 5 is the mobile body. In this case, the target logical formula generation unit 32 sets the following logic proposition representing “finally all robots are present in the area G” as a logical formula representing the objective task.

∧ᵢ⋄□gᵢ

In addition, in a case where two constraint conditions, namely, “the robots do not interfere with each other” and “the robot i always does not interfere with the obstacle O”, are included in the constraint condition information I2, the target logical formula generation unit 32 converts these constraint conditions into the logical formulae. In detail, the target logical formula generation unit 32 converts the above-described two constraint conditions into the following logical formulae, respectively, using the proposition “oᵢ” and the proposition “h” defined by the abstract state setting unit 31.

□¬h

∧ᵢ□¬oᵢ

Therefore, in this case, the target logical formula generation unit 32 adds the logical formula of these constraint conditions to the logical formula “∧ᵢ⋄□gᵢ” corresponding to the objective task that “finally all the robots exist in the area G” to generate the following target logical formula Ltag.

(∧ᵢ⋄□gᵢ)∧(□¬h)∧(∧ᵢ□¬oᵢ)

Accordingly, even in a case where the robot 5 is the mobile body, the target logical formula generation unit 32 is able to suitably generate the target logical formula Ltag based on a process result of the abstract state setting unit 31.

Next, the target logical formula Ltag considering the environment map b will be described with reference to a case example where the objective task that “finally all robots exist in the area G” is set.

For instance, when the proposition based on the environment map b is denoted by “ρ”, the target logical formula generation unit 32 sets the target logical formula Ltag as follows.

(∧ᵢ⋄□gᵢ∨ρ)∧(□¬h)(∧ᵢ□¬oᵢ)

Here, the proposition p is a proposition that becomes true when a value (also called an “environment evaluation value y”) for evaluating the accuracy represented by the environment map b is greater than a certain threshold value. This threshold is, for instance, a predetermined adaptation value is stored in the memory 12 or the storage device 4.

Furthermore, for instance, the environment evaluation value y is expressed as follows, by using a function “g” where the environment map b is used as an argument.

y=g(b)

Here, the function g is, for instance, when the accuracy of each grid represented by the environment map b is set to “pᵢ” (i=1 to n, where “n” denotes the number of grids), the sum of respective accuracies pᵢ for the grids (that is, g(b)=HTTPᵢ) or a function having the sum and a positive correlation. Note that the “pᵢ” may be a value obtained by converting the environment map b with continuously specified accuracy to a discrete value for each grid.

The target logical formula Ltag described above is true when “∧ᵢ⋄□gᵢ” is satisfied or when “p” is satisfied (that is, when the environment evaluation value y is equal to or greater than the threshold value). Note that in a case where the abstract state of the object related to the objective task is not set (that is, an unset object exists), the robot controller 1 considers the logical formula “∧ᵢ⋄□gᵢ” corresponding to the objective task to be false. For instance, in an example in FIG. 6, in a case where it is not possible for the measurement device 7 to measure the area G in the initial state and the information of the area G is not stored in the map-object preliminary information I8, the state vector related to the area G is not set. Therefore, in this case, the robot controller 1 regards the logical formula “∧ᵢ⋄□gᵢ” corresponding to the purpose task as false.

Accordingly, when “∧ᵢ⋄□gᵢ” is regarded as false, an optimization is performed on the operation of the robot 5 in the control input generation unit 36 so that the value of “p” is true (that is, the environment evaluation value y is equal to or greater than the threshold value). Therefore, in this case, the operation plan of the robot 5 is performed so as to measure an area with low accuracy in the environment map b, and the measurement of the unset object is performed in priority as a result. For instance, in the example in FIG. 6, in a case where the area G is present in the blind spot of the measurement device 7 formed by the obstacle 72, the operation plan of the robot i is formulated such as to measure the area of the blind spot portion of the measurement device 7 with low accuracy in the environment map b.

(5-3) Time Step Logical Formula Generation Unit

The time step logical formula generation unit 33 determines the number of time steps (also referred to as a “target time step number”) for completing the objective task, and determines a combination of propositions which represent the state at every time step such that the target logical formula Ltag is satisfied with the target time step number. Since there are usually a plurality of combinations, the time step logical formula generation unit 33 generates the logical formula in which these combinations are combined by the logical sum as the time step logical formula Lts. The above-described combination corresponds to a candidate for the logical formula representing a sequence of operations to be instructed to the robot 5, and is also referred to as a “candidate φ” hereafter.

Here, a specific example of the process of the time step logical formula generation unit 33 will be described in the description of the pick-and-place illustrated in FIG. 5.

Here, for simplicity of explanations, it is assumed that the objective task of “finally the target object i (i=2) is present in the area G” is set, and the following target logical formula Ltag corresponding to this objective task is supplied from the target logical formula generation unit 32 to the time step logical formula generation unit 33. In this case, it is assumed that there is no unset object, and the explanation of the proposition p will be omitted for convenience.

(⋄□g₂)∧(□¬h)∧(∧ᵢ□¬oᵢ)

In this instance, the time step logical formula generation unit 33 uses the proposition “g_{i,k}” which is an extension of the proposition “gᵢ” so as to include the concept of the time steps. The proposition “g_{i,k}” is a proposition that the target object i exists in the area G at a time step k.

Here, when the target time step number is set to “3”, the target logical formula Ltag is rewritten as follows.

(⋄□g_{2,3})∧(∧_{k=1,2,3}□¬hₖ)∧(∧_{i,k=1,2,3}□¬o_{i,k})

Moreover, “⋄□g_{2,3}” can be rewritten as illustrated in the following equation (1).

[Math 1]

⋄□g_{2,3}=(¬g_{2,1}∧¬g_{2,2}∧g_{2,3})∧(¬g_{2,1}∧g_{2,2}∧g_{2,3})∧(g_{2,1}∧¬g_{2,2}∧g_{2,3})∧(g_{2,1}∧g_{2,2}∧g_{2,3}) (1)

At this time, the target logical formula Ltag described above is represented by the logical sum (φ₁∧φ₂∧φ₃∧φ₄) of the four candidates “φ₁” to “φ₄” illustrated in the following an equation (2) to an equation (5).

[Math 2]

ϕ₁=(¬g_{2,1}∧¬g_{2,2}∧g_{2,3})∧(∧_{k=1,2,3}□¬hₖ)∧(∧_{i,k=1,2,3}□¬o_{i,k}) (2)

ϕ₂=(¬g_{2,1}∧g_{2,2}∧g_{2,3})∧(∧_{k=1,2,3}□¬hₖ)∧(∧_{i,k=1,2,3}□¬o_{i,k}) (3)

ϕ₃=(g_{2,1}∧¬g_{2,2}∧g_{2,3})∧(∧_{k=1,2,3}□¬hₖ)∧(∧_{i,k=1,2,3}□¬o_{i,k}) (4)

ϕ₄=(g_{2,1}∧g_{2,2}∧g_{2,3})∧(∧_{k=1,2,3}□¬hₖ)∧(∧_{i,k=1,2,3}□¬o_{i,k}) (5)

Therefore, the time step logical formula generation unit 33 defines the logical sum of the four candidates φ₁ to φ₄ as the time step logical formula Lts. In this case, the time step logical formula Lts is true when at least one of the four candidates φ₁ to φ4 is true. Instead of being incorporated into candidates φ₁ to φ₄, the portion “(∧_{k=1,2,3}□¬hₖ)∧(∧_{i,k=1,2,3}□¬o_{i,k})” corresponding to the constraint conditions of the respective candidates φ₁ to φ₄ may be combined with the candidates φ₁ to φ₄ by the logical production in the optimization process performed by the control 10 input generation unit 36.

Next, a case where the robot 5 illustrated in FIG. 6 is the mobile body will be described. Here, for the sake of simplicity of explanations, it is assumed that the objective task of “finally the target object i (i=2) is present in the area G” is set, and the following target logical formula Ltag corresponding to this objective task is supplied from the target logical formula generation unit 32 to the time step logical formula generation unit 33. In this instance, the following target logical formula Ltag is supplied from the target logical formula generation unit 32 to the time step logical formula generation unit 33. Note that in this case, it is assumed that there is no unset object, and the explanation of the proposition p will be omitted for convenience.

(∧ᵢ⋄□g₂)∧(□¬h)∧(∧ᵢ□¬oᵢ)

In this instance, the time step logical formula generation unit 33 uses the proposition “g_{i,k}” in which the proposition “gᵢ” is extended to include the concept of time steps. Here, the proposition “g_{i,k}” is a proposition that “the robot i exists in the 25 area G at the time step k”. Here, in a case where the target time step number is set to “3”, the target logical formula Ltag is rewritten as follows.

(⋄□g_{2,3})∧(∧_{k=1,2,3}□¬hₖ)∧(∧_{i,k=1,2,3}□¬o_{i,k})

Also, “⋄□g_{2,3}” can be rewritten to the equation (1) similar to the example of the pick-and-place. Similar to example of the pick-and-place, the target logical formula Ltag is represented by the logical sum (φ₁∧Φ₂∧φ₃∧φ₄) of the four candidates “φ₁” to “φ₄” represented in the equations (2) to (5). Therefore, the time step logical formula generation unit 33 defines the logical sum of the four candidates “φ₁” to “φ₄” as the time step logical formula Lts. In this case, the time step logical formula Lts is true when at least one of the four candidate “φ₁” to “φ₄” is true.

When there is the unset object, the time step logical formula generation unit 33 determines one or more candidates φ satisfying the proposition p and generates a logical formula in which a combination of the candidates φ is combined by the logical sum as the time step logical formula Lts.

Next, a method for setting the target time step number will be supplementarily described.

For instance, the time step logical formula generation unit 33 determines the target time step number based on the estimated time of the work specified by the input signal supplied from the instruction device 2. In this case, the time step logical formula generation unit 33 calculates the target time step number from the above-described estimated time based on information of a time span per time step stored in the memory 12 or the storage device 4. In another example, the time step logical formula generation unit 33 stores the information corresponding to the target time step number suitable for each type of the objective task in advance in the memory 12 or the storage device 4, and determines the target time step number according to the type of the objective task to be executed by referring to the information.

Preferably, the time step logical formula generation unit 33 sets the target time step number to a predetermined initial value. Next, the time step logical formula generation unit 33 gradually increases the target time step number until the time step logical formula Lts for the control input generation unit 36 to determine the control input is generated. In this case, the time step logical formula generation unit 34 adds a predetermined number (an integer equal to or greater than 1) to the target time step number in a case where the optimal solution is not derived as a result of the optimization process performed by the control input generation unit 36 according to the set target time step number.

At this time, the time step logical formula generation unit 33 may set the initial value of the target time step number to be a value smaller than the number of time steps corresponding to the working time of the objective task which the user expects. Therefore, it is possible for the time step logical formula generation unit 33 to suitably suppress setting the target time step number to be an unnecessarily large.

(5-4) Environment Map Update Unit

First, at the time of the operation plan prior to the robot operation period Tw, the environment map update unit 34 generates the environment map b used for generating the control signal S1. In this instance, the environment map update unit 34 generates the environment map b based on the measurement signal S2 using a technique such as Occupancy Grid Maps capable of generating a probabilistic map in a target space or a target area, for instance. In this case, the accuracy of the space measured by the measurement device 7 (also referred to as a “measured space”) is set to a value higher than the accuracy of the space which is not measured by the measurement device 7 (also referred to as an “unmeasured space”). Moreover, the environment map update unit 34 generates the environment map b based on both the map-object preliminary information I8 and the measurement signal S2 in a case of including information specifying the initial state of the environment map bin the map-object preliminary information I8.

FIG. 7 is a bird's-eye view of the workspace of the robot 5 schematically representing the relationship between an unmeasured space 50 in the initial state and a measured space 51. In an example in FIG. 7, as an example, the measurement device 7 is fixed with respect to the mobile robot 5, and a measurement range is a semicircle with the front of the robot 5 as a front direction.

In this instance, the environment map update unit 34 recognizes the measured space 51 based on the measurement signal S2, and recognizes the workspace other than the measured space 51 as the unmeasured space 50. Note that the environment map update unit 34 may specify the measured space 51 based on the position and the posture of the robot 5, the installation position and the installation angle of the measurement device 7 with respect to the robot 5, and the viewing angle and the measurable distance of the measurement device 7.

Next, the environment map update unit 34 sets the accuracy of the space of the environment map b corresponding to the measured space 51 (a two-dimensional space, that is, including an area, hereinafter the same) to be a value higher than the accuracy of the space of the environment map b corresponding to the unmeasured space 50. Note that in a simple example, the environment map update unit 34 sets the accuracy of the space of the environment map b corresponding to the measured space 51 as a maximum value “1”, and the accuracy of the space of the environment map b corresponding to the unmeasured space 50 as a minimum value “0”. Incidentally, in addition to this example embodiment, the environment map update unit 34 may set the accuracy of the space of the environment map b to any real value from 0 to 1 based on a technique such as the above-described Occupancy Grid Maps. In addition, the environment map b may have information of the accuracy for each two-dimensional or three-dimensional grid as a map of the discrete values.

Furthermore, the environment map update unit 34 updates the environment map b at predetermined time intervals in the robot operation period Tw in which the robot 5 operates, based on the most recent measurement signal S2 outputted by the measurement device 7.

FIG. 8 is a bird's-eye view of the workspace of the robot 5 schematically representing a relationship between the unmeasured space 50 after the robot 5 has moved according to a movement trajectory 54 and the measured space 51. In an example in FIG. 8, the robot 5 is moving straight by a predetermined distance from the initial position illustrated in FIG. 7. In this instance, the environment map update unit 34 recognizes the measured space 51 based on the control signal S1. In FIG. 8, the measured space 51 in the initial state is regarded as an existing measurement space 510, and the measured space 51 newly measured in accordance with the movement of the robot 5 is displayed as a new measurement space 520. In this case, the environment map update unit 34 updates the environment map b so that the accuracy of the environment map b corresponding to the measured space 51 becomes a value higher than the accuracy of the environment map b corresponding to the unmeasured space 50.

Here, the map update model b⁺ will be supplementarily described. The map update model b⁺ is a model that predicts the time change of the environment map b based on the map update model b and the state vector at a time of the operation plan, and the predicted input vector entered to the robot 5. For instance, in a case of inputting the state vector and the environment map b corresponding to the initial state illustrated in FIG. 7 and the input vector for moving the robot 5 along the movement trajectory 54, the map update model b⁺ outputs the environment map b having the accuracy of an area corresponding to the new measurement space 520 illustrated in FIG. 8. The map update model b⁺ is described further in the section “(5-5) Abstract Model Generation Unit”.

(5-5) Abstract Model Generation Unit

The abstract model generation unit 35 generates the abstract model Σ based on the dynamics model information I5, the abstract state setting information IS, the environment map b, and the map update model b⁺. Here, the abstract model Σ is a model which represents the dynamics model and the map update model b⁺. In the following, first, the dynamics model of the abstract model Σ will be described.

For instance, the dynamics model will be described in a case where the objective task is the pick-and-place. In this instance, a general-purpose abstract model that does not specify the positions and the number of target objects, the position of the area where the target objects are placed, the number of the robots 5 (or the number of the robot arms 52), or the like is recorded in the dynamics model information I5. Next, the abstract model generation unit 35 generates the dynamics model by reflecting the recognition result of the object by the abstract state setting unit 31 with respect to the model of the general-purpose type including the dynamics of the robot 5 recorded in the dynamics model information I5. Accordingly, the abstract model Σ is a model in which the state of the object in the workspace and the dynamics of the robot 5 are expressed abstractly. In the case of the pick-and-place, the state of the object in the workspace indicates the positions and the numbers of the target objects, the positions of the areas where the objects are placed, the number of the robots 5, and the like.

Here, the dynamics in the workspace frequently switches when working on the objective task with the pick-and-place. For instance, in the example of the pick-and-place illustrated in FIG. 5, when the robot arm 52 is grabbing the target object i, the target object i can be moved, but when the robot arm 52 is not grabbing the target object i, the target object i cannot be moved.

With consideration of the above, in the present example embodiment, in the case of the pick-and-place, the operation of grasping the target object i is represented abstractly by a logical variable “δᵢ”. In this case, for instance, the abstract model generation unit 35 can determine the dynamics model of the abstract model Σ to be set for the workspace in the example of the pick-and-place in FIG. 5 by using the following equation (6).

$$\begin{matrix}[ Math 3 ] & \\ {[ \begin{matrix}{x}_{r 1} \\ {x}_{r 2} \\ {x}_{1} \\ ⋮ \\ {x}_{4}\end{matrix} ]}_{k + 1} = {I [ \begin{matrix}{x}_{r 1} \\ {x}_{r 2} \\ {x}_{1} \\ ⋮ \\ {x}_{4}\end{matrix} ]}_{k} + [ \begin{matrix}I & 0 \\ 0 & I \\ {δ}_{1 , 1} I & {δ}_{2 , 1} I \\ ⋮ & ⋮ \\ {δ}_{1 , 4} I & {δ}_{2 , 4} I\end{matrix} ] [ \begin{matrix}{u}_{1} \\ {u}_{2}\end{matrix} ] & ( 6 )\end{matrix}$$

$${h}_{{ij}_{min}} ( 1 - {δ}_{i} ) \leq {h}_{ij} ( x ) \leq {h}_{{ij}_{max}} {δ}_{i} + ( {δ}_{i} - 1 ) ε$$

Here, “uⱼ” denotes the control input for controlling the robot hand j (“j=1” indicates the robot hand 53a, and “j=2” indicates the robot hand 53b), “I” denotes an identity matrix, and “0” denotes a zero matrix. Note that although the control input is here assumed as speed as an example, the control input may be acceleration. Also, “δ_{j,i}” denotes a logical variable which indicates “1” when the robot hand j grabs the target object i and indicates “0” otherwise. Also, “xᵣ₁” and “xᵣ₂” denote the position vectors of the robot hands j (j=1, 2), and “x₁” to “x₄” denote the position vectors of the target objects i (i=1 to 4). In addition, “h(x)” denotes a variable which satisfies “h(x)≥0” when the robot hand exists in a vicinity of the target object to the extent that the target object can be grasped, and which satisfies the following relationship with the logical variable δ.

δ=1↔h(x)≥0

In this equation, when the robot hand exists in the vicinity of the target object to the extent that the target object can be grasped, it is considered that the robot hand grasps the target object, and the logical variable δ is set to 1.

Here, the equation (6) is a difference equation representing the relationship between the state of the object at the time step k and the state of the object at the time step k+1. Then, in the above-described equation (6), since the state of grasping is represented by the logical variable which is the discrete value, and the movement of the object is represented by a continuous value, the equation (6) illustrates the hybrid system.

Moreover, in the equation (6), it is considered that only the dynamics of the robot hand, which is the hand tip of the robot 5 actually grasping the target object, is considered, rather than the detailed dynamics of the entire robot 5. By this consideration, it is possible to suitably reduce a calculation amount of the optimization process by the control input generation unit 35.

Moreover, the abstract model information I5 records information concerning the logical variable corresponding to the operation (the operation of grasping the target object i in the case of the pick-and-place) for which dynamics are switched, and information for deriving the difference equation according to the equation (6) from the recognition result of an object based on the measurement signal S2 or the like. Therefore, it is possible for the abstract model generation unit 35 to determine the dynamics model of the abstract model Σ in line with the environment of the target workspace based on the dynamics model information I5 and the recognition result of the object even in a case where the positions and the number of the target objects, the areas (the area G in FIG. 5) where the target objects are placed, the number of the robots 5, and the like vary.

Note that in a case where another working body exists, information concerning the abstracted dynamics of another working body may be included in the dynamics model information I5. In this case, the dynamics model of the abstract model Σ is a model in which the state of the objects in the workspace, the dynamics of the robot 5, and the dynamics of another working object are abstractly expressed. In addition, the abstract model generation unit 35 may generate a model of the hybrid system with which a mixed logic dynamical (MLD: Mixed Logical Dynamical) system, a Petri net, an automaton, or the like is combined, instead of the model represented in the equation (6).

Next, the dynamics model of the abstract model Σ will be described in a case where the robot 5 illustrated in FIG. 6 is the mobile body. In this instance, the abstract model generation unit 35 determines the dynamics model of the abstract model Σ to be set for the workspace illustrated in FIG. 6 using a state vector x1 for the robot (i=1) and a state vector x2 for the robot (i=2) by the following equation (7).

$$\begin{matrix}[ Math 4 ] & \\ {[ \begin{matrix}{x}_{1} \\ {x}_{2}\end{matrix} ]}_{k + 1} = {[ \begin{matrix}{A}_{1} & O \\ O & {A}_{2}\end{matrix} ] [ \begin{matrix}{x}_{1} \\ {x}_{2}\end{matrix} ]}_{k} + {[ \begin{matrix}{B}_{1} & 0 \\ 0 & {B}_{2}\end{matrix} ] [ \begin{matrix}{u}_{1} \\ {u}_{2}\end{matrix} ]}_{k} & ( 7 )\end{matrix}$$

Here, “u₁” represents the input vector for the robot (i=1), and “u₂” represents the input vector for the robot (i=2). Also, “A₁”, “A₂”, “B₁”, and “B₂” are matrixes and are defined based on the dynamics model information I5.

In another example, in a case where there are a plurality of operation modes of the robot i, the abstract model generation unit 35 may represent the dynamics model of the abstract model Σ to be set with respect to the workspace depicted in FIG. 6, by the hybrid system in which the dynamics are switched according to the operation mode of the robot i. In this instance, when the operation mode of the robot i is set to “mi”, the abstract model generation unit 35 determines the dynamics model of the abstract model Σ to be set with respect to the workspace illustrated in FIG. 6 by the following equation (8).

$$\begin{matrix}[ Math 5 ] & \\ {[ \begin{matrix}{x}_{1} \\ {x}_{2}\end{matrix} ]}_{k + 1} = {[ \begin{matrix}{A}_{1 {m}_{1}} & O \\ O & {A}_{{2}_{{m}_{2}}}\end{matrix} ] [ \begin{matrix}{x}_{1} \\ {x}_{2}\end{matrix} ]}_{k} + {[ \begin{matrix}{B}_{{1}_{{m}_{1}}} & O \\ O & {B}_{{2}_{{m}_{2}}}\end{matrix} ] [ \begin{matrix}{u}_{1} \\ {u}_{2}\end{matrix} ]}_{k} & ( 8 )\end{matrix}$$

Accordingly, even in a case where the robot 5 is the mobile body, it is possible for the abstract model generation unit 35 to suitably determine the dynamics model of the abstract model Σ. The abstract model generation unit 35 may generate a model of the hybrid system in which the MLD system, the Petri net, an automaton, or the like is combined, instead of the model represented by the equation (7) or the equation (8).

The vector xᵢ and the input uᵢ representing the states of the target object and the robot 5 in the abstract model illustrated in the equations (6) to (8) and the like may be discrete values. Even in a case where the vector xᵢ and the input uᵢ are represented discretely, the abstract model generation unit 35 can set an abstract model machine that suitably abstracts the actual dynamics. In addition, when the objective task in which the robot 5 moves and performs the pick-and-place is set, the abstract model generation unit 35 sets the dynamics model on the assumption of switching of the operation mode as illustrated in the equation 8, for instance.

Next, the map update model b⁺ to be included in the abstract model Σ will be described.

Based on the environment map b at a certain point in time, the state vector x, and an input vector u to the robot 5 at a certain point in time, the map update model b⁺ is a function that predicts the environment map b at a next point in time. Accordingly, the environment map b is represented by the following difference equations using the state vector x, the input vector u to the robot 5, a function “f” corresponding to the map update model b⁺, the time step k, and an error vector “nv”.

bₖ₊₁=f(bₖ,xₖ,uₖ)+nvₖ

Information concerning the function f and the error vector nv is stored, for instance, in the map update model information I7. In addition, the state vector x, the input vector u and the environment map b are expressed as follows. Here, the number of robots 5 is assumed to be “M”, and the environment map b is assumed to be a discrete map of the number of grids “n”.

x=[x₁^{T},x₂^{T} . . . ,x_{M}^{T}]^{T}

u=[u₁^{T},u₂^{T} . . . ,u_{M}^{T}]^{T}

b=[p₁,p₂ . . . ,pₙ]T

Each of elements x₁, x₂ . . . , x_{M}, u₁, u₂ . . . , u_{M} is a vector representing a condition or an input for each robot, and the pᵢ∈[0,1] (i=1 to n) represents the accuracy of each grid. Also, x and u are expressed as follows, for instance, in a case of the dynamics model illustrated in the equation (7).

xₖ₊₁=Axₖ+Buₖ

In the above-described difference equation regarding the environment map b, the error vector nv is used to stochastically determine the environment map b; alternatively, the environment map b may be deterministically determined without using the error vector nv.

(5-6) Control Input Generation Unit

The control input generation unit 36 determines an optimum control input to the robot 5 for each time step, based on the time step logical formula Lts supplied from the time step logical formula generation unit 33 and the abstract model Σ supplied from the abstract model generation unit 35. In this case, the control input generation unit 36 defines the evaluation function for the objective task, and solves the optimization problem for minimizing the evaluation function using the abstract model Σ and the time step logical formula Lts as the constraint conditions. For instance, the evaluation function is predetermined for each type of the objective task, and is stored in the memory 12 or the storage device 4.

For instance, the control input generation unit 36 sets the evaluation function based on the control input “uₖ” and the environment evaluation value y. In this case, the control input generation unit 36 minimizes the evaluation function such that the smaller the control input uₖ (that is, the smaller the energy consumed by the robot 5 is), and the larger the environment evaluation value y is (that is, the higher the accuracy of the information in the whole workspace is), when there is the unset object. In detail, the control input generation unit 36 solves a constrained mixed integer optimization problem shown in the following equation (9) in which the abstract model Σ and the logical formula the time step logical formula Lts (that is, the logical sum of the candidates φ₁) are the constraint conditions.

$$\begin{matrix}[ Math 6 ] & \\ {min}_{u} ( {\sum }_{k = 0}^{T} ( {‖ {u}_{k} ‖}^{2} - α {y}_{k} ) ) & ( 9 )\end{matrix}$$

$$s . t . \sum ( {∨}_{i} {ϕ}_{i} ) ∧ \{ {ρ}_{T} ∧ ( ¬ h ) ∧ ( {∧}_{i} {o}_{i} ) \}$$

“α” denotes a constant equal to or more 0, and “T” denotes the number of time steps to be optimized, may be the number of target time steps, and may be a predetermined number smaller than the number of target time steps.

Here, the term “−αyₖ” of the evaluation function and the logical formula “ρ_{T}∧(□¬h)∧(∧ᵢ□¬oᵢ)” are provided considering a case where there is the unset object. By providing them, the control input uₖ can be determined to increase the accuracy of the environment map b while satisfying the general constraint conditions defined by “h” and “oᵢ”.

Preferably, in a case where the unset object exists, the control input generation unit 36 may automatically determine that the logical sum “∧ᵢφᵢ” of the candidates φᵢ corresponding to the time step logical formula Lts is false. On the other hand, in a case where no unset object exits, the control input generation unit 36 may suitably perform the optimization of the control input uₖ by deleting the term “−αyₖ” of the evaluation function and the logical formula “ρ_{T}∧(□¬h)∧(∧ᵢ□¬oᵢ)”.

In this way, the control input generation unit 36 determines the optimum control input uₖ by solving the optimization problem including the environment evaluation value y and the proposition p based on the environment map b and the map update model b⁺. Accordingly, the control input generation unit 36 determines the control input uₖ so as to increase the accuracy of the information in the workspace and measure the set object when there is an unconfigured object, and determines the control input uₖ so as to achieve the objective task in the case where no unset object exits.

Moreover, preferably, the control input generation unit 36 may approximate a logical variable to a continuous value (a continuous relaxation problem). Accordingly, the control input generation unit 36 can suitably reduce the amount of computation. Note that in a case where a STL is used instead of the linear logical formula (LTL), the logical formula can be described as a nonlinear optimization problem. Moreover, the environment map b and map update model b⁺ may be incorporated into the optimization issues based on any method of a reinforcement learning, other than the methods described above.

Furthermore, in a case where the target time step number is greater (for instance, greater than a predetermined threshold value), the control input generation unit 36 may set the time step number used for the optimization to a value (for instance, the above-described threshold) smaller than the target time step number. In this case, the control input generation unit 36 sequentially determines the control input uₖ by solving the above-described optimization problem every time a predetermined number of time steps elapses. In this case, the control input generation unit 36 may solve the above-described optimization problem for each predetermined event corresponding to the intermediate state for the achievement state of the objective task, and determine the control input uₖ. In this case, the control input generation unit 36 sets the number of time steps until a next event occurs, to the number of time steps used for optimization. The above-described event is, for instance, an event in which the dynamics in the workspace are switched. For instance, in a case where the pick-and-place is the objective task, an event is defined such as an event in which the robot 5 grasps the target object, an event in which the robot 5 finishes carrying one object to the destination of the plurality of target objects to be carried, or another event. For instance, the event is defined in advance for each type of the objective task, and information specifying the event for each type of the objective task is stored in the storage device 4.

(5-7) Robot Control Unit

The robot control unit 37 generates a sequence of subtasks based on the control input information Icn supplied from the control input generation unit 36 and the subtask information I4 stored in the application information storage unit 41. In this instance, the robot control unit 37 recognizes the subtask that can be accepted by the robot 5 by referring to the subtask information I4, and converts the control input for each time step indicated by the control input information Icn into the subtask.

For instance, in the subtask information I4, two subtasks for moving (reaching) of the robot hand and grasping of the robot hand are defined as subtasks that can be accepted by the robot 5 in a case where the objective task is the pick-and-place. In this case, the function “Move” representing the reaching is, for instance, a function in which the initial state of the robot 5 prior to the execution of the function, the final state of the robot 5 after the execution of the function, and the time necessary to execute the function are respective arguments. In addition, the function “Grasp” representing the grasping is, for instance, a function in which the state of the robot 5 before the execution of the function, the state of the target object to be grasped before the execution of the function, and the logical variable δ are respective arguments. Here, the function “Grasp” represents a grasping operation for the logical variable δ that is “1”, and represents a releasing operation for the logic variable δ that is “0”. In this instance, the robot control unit 37 determines the function “Move” based on the trajectory of the robot hand determined by the control input for each time step indicated by the control input information Icn, and determines the function “Grasp” based on the transition of the logical variable δ for each time step indicated by the control input information Icn.

Accordingly, the robot control unit 37 generates a sequence formed by the function “Move” and the function “Grasp”, and supplies the control signal S1 representing the sequence to the robot 5. For instance, in a case where the objective task is “finally the target object i (i=2) is present in the area G”, the robot control unit 37 generates the sequence of the function “Move”, the function “Grasp”, the function “Move”, and the function “Grasp” for the robot hand closest to the target object (i=2). In this instance, the robot hand closest to the target object (i=2) moves to the position of the target object (i=2) by the first function “Move”, grasps the target object (i=2) by the first function “Grasp”, moves to the area G by the second function “Move”, and places the target object (i=2) in the area G by the second function “Grasp”.

(5-8) Abstraction State Comparison Unit

The abstract state comparison unit 38 compares the measurement abstract state Stm supplied from the abstract state setting unit 31 with the prediction abstract state Stp based on the control input information Icn in the robot operation period Tw, and tests whether or not the abstract model Σ needs to be reproduced. Here, a method for acquiring prediction abstract state Stp will be supplementarily described. The abstract state comparison unit 38 recognizes, for instance, the trajectory of the state of the respective objects which is predicted for each time step based on the control input information Icn representing a process result of the optimization process executed by the control input generation unit 36. After that, the abstract state comparison unit 38 determines a state predicted at the time step corresponding to a current time as the prediction abstract state Stp.

Here, in a case where it is determined that there is a substantial difference between the measurement abstract state Stm and the prediction abstract state Stp, the abstract state comparison unit 38 determines that the abstract model Σ needs to be re-generated. The case where “there is a substantial difference between the measurement abstract state Stm and the prediction abstract state Stp” means, for instance, a case where the number of objects defining the abstract state is different, a case where the position of the same object differs by a specified distance or more, or a case where another predetermined condition is satisfied. In this case, the abstract state comparison unit 38 suitably determines that the re-generation of the abstract model Σ is needed, for instance, in a case where the unset object is detected by the measurement device 7 or in a case where it is detected that there is a difference between the abstract state of the object set based on the map-object preliminary information I8 and a measurement result of the object. Note that the abstract state comparison unit 38 determines that the re-generation of the abstract model is necessary in a case where an unpredictable obstacle occurs, in a case where there is an object that performs an unpredictable motion, and in another case, in addition to the above case.

Next, when it is determined that the abstract model Σ needs to be re-generated, the abstract state comparison unit 38 supplies the measurement abstract state Stm to the abstract model generation unit 35. Note that the measurement abstract state Stm is the most recent one that represents the abstract state of the position, the posture, or the like of each of the objects (including the detected unset object) in the workspace. Next, the abstract model generation unit 35 generates the abstract model Σ reflecting the present abstract state based on the measurement abstract state Stm and the most recent environment map b generated by the environment map update unit 34. After that, the control input generation unit 36 constructs the optimization problem represented by the equation (9) using the generated abstract model Σ as the constraint condition, and solves the constructed optimization problem. Therefore, it is possible for the control input generation unit 36 to suitably generate the control input representing the optimal operation plan of the robot 5 considering the most recent abstract state. Thus, the operation of the robot 5 is re-planned, and the sequence of the operations of the robot 5 is suitably determined based on the latest measurement result.

(6) Process Flow

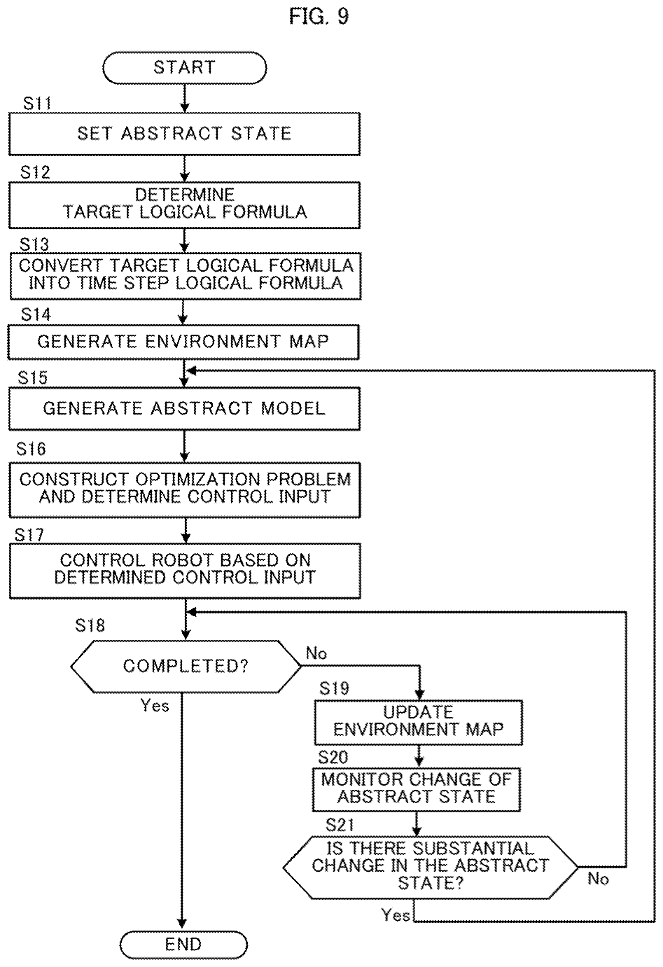

FIG. 9 is an example of a flowchart illustrating an outline of a robot control process executed by the robot controller 1 in the first example embodiment.

First, the abstract state setting unit 31 of the robot controller 1 sets the abstract state of each object existing in the workspace (step S11). Here, the abstract state setting unit 31 executes step S11, for instance, when an external input instructing an execution of a predetermined objective task is received from the instruction device 2 or the like. In step S11, the abstract state setting unit 31 sets a state vector such as the proposition, the position, and the posture concerning each object related to the objective task based on, for instance, the abstract state specification information I1, the object model information I6, the map-object preliminary information I8, and the measurement signal S2. Note that the abstract state setting unit 31 sets the proposition concerning each unset object with the state vector such as the position relative to the unset object being undefined when it is determined that the unset object exists based on the measurement signal S2 and the abstract state specification information I1.

Next, the target logical formula generation unit 32 determines the target logical formula Ltag based on the abstract state setting information IS representing the process result of step S11 (step S12). In this case, the target logical formula generation unit 32 adds the constraint condition in executing the objective task to the target logical formula Ltag by referring to the constraint condition information I2.

Next, the time step logical formula generation unit 33 converts the target logical formula Ltag into the time step logical formula Lts representing the state at every time step (step S13). In this instance, the time step logical formula generation unit 34 determines the target time step number, and generates, as the time step logical formula Lts, the logical sum of candidates φ each representing the state at every time step such that the target logical formula Ltag is satisfied with the target time step number. In this instance, preferably, the time step logical formula generation unit 33 may determine the feasibility of the respective candidates φ by referring to the operation limit information I3, and may exclude the candidates φ that are determined to be non-executable from the time step logic Lts.

Next, the environment map update unit 34 generates the environment map b (step S14). In this instance, the environment map update unit 34 generates the environment map b based on the measurement signal S2 and the map-object preliminary information I8. Next, the abstract model generation unit 35 generates the abstract model Σ (step S15). In this case, the abstract model generation unit 35 generates the abstract model representing the dynamic model and the map update model b⁺ based on the environment map b, the abstract state setting information IS, the dynamic model information I5, the map update model information I7, and the like.

After that, the control input generation unit 36 constructs the optimization problem based on the process result of step S11 to step S15, and determines the control input by solving the constructed optimization problem (step S16). In this case, for instance, the control input generation unit 36 constructs an optimization problem as illustrated in the equation (9), determines the control input such as to minimize the evaluation function set based on the control input and the environment evaluation value y.

Next, the robot control unit 37 controls the robot 5 based on the control input determined in step S16 (step S17). In this case, for instance, the robot control unit 37 converts the control input determined in step S16 into a sequence of subtasks which the robot 5 can interpret by referring to the subtask information I4, and supplies the control signal S1 representing the sequence to the robot 5.

After that, the robot controller 1 determines whether or not the objective task has been completed (step S18). The robot controller 1 determines that the objective task has been completed, for instance, when a signal representing the normal completion is received from the robot 5 or when it is detected based on the measurement signal S2 that the object in the workspace has reached a goal of achieving the objective task. In response to the determination of that the objective task has been completed (step S18; Yes), the robot controller 1 terminates the process of the flowchart. On the other hand, with respect to a case where the objective task has not completed (step S18; No), the environment map update unit 34 updates the environment map b based on the most recent measurement signal S2 (step S19).

Next, the abstract state comparison unit 38 monitors a change of the abstract state (step S20). Specifically, the abstract state comparison unit 38 recognizes the prediction abstract state Stp representing the abstract state to be predicted at the time of comparison based on the control input information Icn representing the proces result of the optimization process executed by the control input generation unit 36. Subsequently, the abstract state comparison unit 38 compares the measurement abstract state Stm representing the abstract state, which is set by the abstract state setting unit 31 based on the most recent measurement signal S2, with the prediction abstract state Stp.

Next, the abstract state comparison unit 38 determines whether or not there is a substantial change in the abstract state (step S21). Then, when the abstract state comparison unit 38 determines that there is the substantial change in the abstract state (step S21; Yes), the robot control process advances to step S15. After that, generation of the abstract model Σ, generation of the control input, or the like is performed, and a re-determination of the operation plan of the robot 5 is performed based on the most recent abstract state. On the other hand, when the abstract state comparison unit 38 determines that there is no substantial change in the abstract state (step S21; No), the robot control process returns to and continuously performs step S18. In this case, the control of the robot 5 continues based on the initial operation plan.

(7) Modification

The functional block configuration of the processor 11 illustrated in FIG. 4 is an example, and various changes may be made.

For instance, information of the candidates φ of the sequence of operations to be instructed to the robot 5 is stored in advance in the storage device 4, and the processor 11 executes the optimization process of the control input generation unit 36 based on the information. By the optimization process, the processor 11 performs a selection of the optimum candidate φ and a determination of the control input of the robot 5. In this instance, there is no necessary for the processor 11 to have functions corresponding to the target logical formula generation unit 32 and the time step logical formula generation unit 33 in generating the control signal S1. Thus, information concerning the execution result of a part of the functional blocks of the processor 11 illustrated in FIG. 4 may be previously stored in the application information storage unit 41.

In another example, the application information includes design information such as a control input corresponding to an objective task or a flowchart for designing a subtask sequence, and the robot controller 1 may generate the control input or the subtask sequence by referring to the design information. In this case, for instance, the robot controller 1 executes the process flow branched based on the presence or absence of the unset object and/or a threshold process with respect to the environment evaluation value y. A a specific example of executing the task based on a pre-designed task sequence is disclosed in Japanese Laid-open Patent Publication No. 2017-39170, for instance.

### Second Example Embodiment

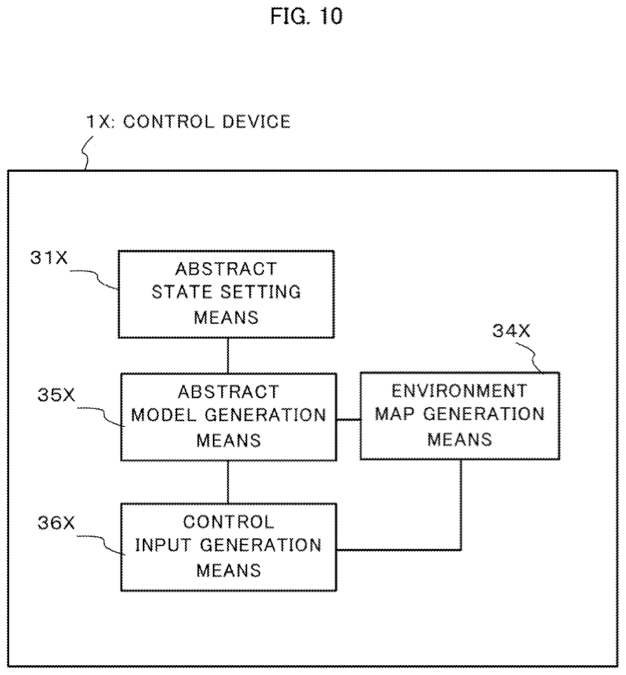

FIG. 10 illustrates a schematic configuration diagram of a control device 1X in the second example embodiment. The control device 1X mainly includes an abstract state setting means 31X, an environment map generation means 34X, an abstract model generation means 35X, and a control input generation means 36X. The control device 1X may be formed by a plurality of devices. For instance, the control device 1X may correspond to the robot controller 1 in the first example embodiment.

The abstract state setting means 31X sets an abstract state which is the abstract state of each object in a workspace in which each robot performs the task. The abstract state setting means 31X may set the abstract state based on the measurement result of a sensor which measures in the workspace, and may set the abstract state based on preliminary information generated in advance. For instance, the abstract state setting means 31X may correspond to the abstract state setting means 31 in the first example embodiment.

The environment map generation means 34X generates an environment map that is a map representing the accuracy of information in the workspace. The environment map generation means 34X may generate the environment map based on a measurement result of a sensor which measures the inside of the workspace, and may set the environment map based on preliminary information generated in advance. For instance, the environment map generation means 34X may correspond to the environment map update means 34 according to the first example embodiment.

The abstract model generation means 35X generates the abstract model representing the dynamics of the abstract state and a time change of the environment map. For instance, the abstract model generation means 35X may be the abstract model generation means 35 in the first example embodiment.

The control input generation means 36X generates control inputs for the robot based on the abstract model. For instance, the control input generation means 36X may correspond to the control input generation unit 36 in the first example embodiment.

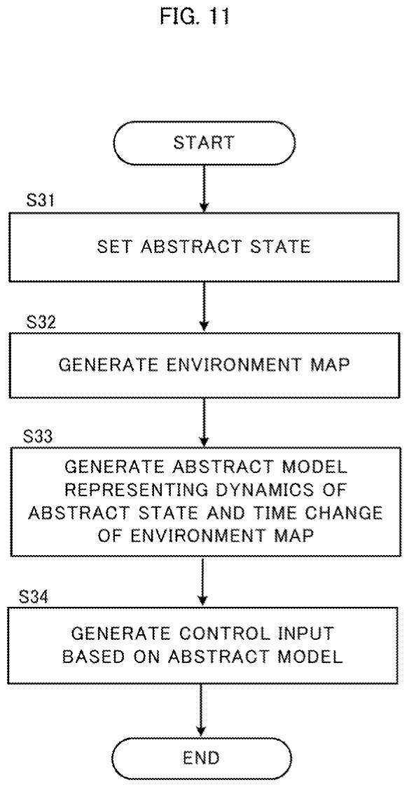

FIG. 11 is an example of a flowchart which the control device 1X in the second example embodiment executes. First, the abstract state setting means 31X sets the abstract state which is an abstract state of each object in the workspace in which each robot performs the task (step S31). The environment map generation means 34X generates the environment map in the workspace (step S32). Incidentally, step S31 and step S32 are performed in any order, and thus may be performed at the same time or may be performed in a reverse order. The abstract model generation means 35X generates the abstract model representing the dynamics of the abstract state and the time change of the environment map (step S33). The control input generation means 36X generates the control input for the robot based on the abstract model (step S34).

According to the second example embodiment, it is possible for the control device 1X to suitably generate the control input for that the robot suitably operates, in consideration with the uncertainty of information in the workspace.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (that is, a flexible disk, a magnetic tape, a hard disk drive), a magnetic-optical storage medium (that is, a magnetic optical disk), a CD-ROM (Read Only Memory), a CD-R, a CD-R/W, a solid-state memory (that is, a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

In addition, some or all of the above example embodiments may also be described as in the following supplementary notes, but are not limited to the following.

(Supplementary Note 1)

A control device comprising:
an abstract state setting means configured to set an abstract state which abstractly represents a state of each object in a workspace where each robot works;

an environment map generation means configured to generate an environment map which is a map representing accuracy of information in the workspace;
an abstract model generation means configured to generate an abstract model which represents dynamics of the abstract state and a time change of the environment map; and
a control input generation means configured to generate a control input with respect to each robot based on the abstract model.

(Supplementary Note 2)

The control device according to supplementary note 1, further comprising an abstract state comparison means configured to determine whether or not to re-generate the abstract model based on a change of the abstract state during an operation of each robot by the control input.

(Supplementary Note 3)

The control device according to supplementary note 2, wherein the abstract state comparison means determines whether or not to re-generate the abstract model based on at least one of a number and each position of objects during the operation of each robot by the control input.

(Supplementary Note 4)

The control device according to supplementary note 2 or 3, wherein
each robot is provided with a measurement device,
a measurement range of the measurement device changes in accordance with the operation of each robot, and
the abstract state setting means specifies the change of the abstract state based on a measurement signal which the measurement device generates during the operation of each robot.

(Supplementary Note 5)

The control device according to supplementary note 4, wherein the abstract state comparison means determines whether or not to re-generate the abstract model, based on a difference between an abstract state currently set based on the measurement signal and an abstract state currently predicted based on the control input.

(Supplementary Note 6)

The control device according to any one of supplementary notes 1 to 5, wherein the control input generation means generates the control input based on the abstract model and an environment evaluation value in which accuracy represented by the environment map is evaluated.

(Supplementary Note 7)

The control device according to supplementary note 6, wherein the control input generation means sets an evaluation function including the control input and the environment evaluation value and a constraint condition to be satisfied in an execution of an objective task which is a task for each robot to work, and generates the control input using an optimization based on the evaluation function and the constraint condition.

(Supplementary Note 8)

The control device according to any one of supplementary notes 1 to 7, further comprising
a target logical formula generation means configured to generate a target logical formula which is a logical formula of a temporal logic representing a final target; and
a time step logical formula generation means configured to generate, from the logical formula, time step logical formula which is a logical formula representing a state for each time step for executing a certain objective task which is a task for each robot to work,
wherein the control input generation means generates the control input based on the abstract model and the time step logical formula.

(Supplementary Note 9)

The control device according to supplementary note 8, wherein the target logical formula generation means generates the target logical formula including a logical sum of a logical formula corresponding the objective task and an environment evaluation value in which accuracy represented by the environment map is evaluated.

(Supplementary Note 10)

The control device according to any one of supplementary notes 1 to 9, further comprising a robot control means configured to supply a subtask sequence in which the control input is converted into a sequence of subtasks executable for each robot, to a corresponding robot.

(Supplementary Note 11)

The control device according to any one of supplementary notes 1 to 10, wherein the environment map generation means updates the environment map to attenuate the accuracy in a space based on the passage of time after the measurement in the space where the measurement has performed.

(Supplementary Note 12)

A control method comprising:
setting an abstract state which abstractly represents a state of each object in a workspace where each robot works;
generating an environment map which is a map representing accuracy of information in the workspace;
generating an abstract model which represents dynamics of the abstract state and a time change of the environment map; and
generating a control input with respect to each robot based on the abstract model.

(Supplementary Note 13)

A recording medium storing a program, the program causing a computer to perform a process comprising:
setting an abstract state which abstractly represents a state of each object in a workspace where each robot works;
generating an environment map which is a map representing accuracy of information in the workspace;
generating an abstract model which represents dynamics of the abstract state and a time change of the environment map; and
generating a control input with respect to each robot based on the abstract model.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF SYMBOLS

1 Robot controller
1X Control device
30 2 Instruction device
4 Storage device
5 Robot
7 Measurement device
41 Application information storage unit
100 Robot control system

What is claimed is:

1. A control device comprising:
a memory storing instructions; and
one or more processors configured to execute the instructions to:
set an abstract state which abstractly represents a state of each object in a workspace where each robot works;
generate an environment map which is a map representing accuracy of information in the workspace;
generate an abstract model which represents dynamics of the abstract state and a time change of the environment map; and
generate a control input with respect to each robot based on the abstract model.

2. The control device according to claim 1, wherein the processor is further configured to determine whether or not to re-generate the abstract model based on a change of the abstract state during an operation of each robot by the control input.

3. The control device according to claim 2, wherein the processor determines whether or not to re-generate the abstract model based on at least one of a number and each position of objects during the operation of each robot by the control input.

4. The control device according to claim 2, wherein
each robot is provided with a measurement device,
a measurement range of the measurement device changes in accordance with the operation of each robot, and
the processor specifies the change of the abstract state based on a measurement signal which the measurement device generates during the operation of each robot.

5. The control device according to claim 4, wherein the processor determines whether or not to re-generate the abstract model, based on a difference between an abstract state currently set based on the measurement signal and an abstract state currently predicted based on the control input.

6. The control device according to claim 1, wherein the processor generates the control input based on the abstract model and an environment evaluation value in which accuracy represented by the environment map is evaluated.

7. The control device according to claim 6, wherein the processor sets an evaluation function including the control input and the environment evaluation value and a constraint condition to be satisfied in an execution of an objective task which is a task for each robot to work, and generates the control input using an optimization based on the evaluation function and the constraint condition.

8. The control device according to claim 1, wherein the processor is further configured to
generate a target logical formula which is a logical formula of a temporal logic representing a final target; and
generate, from the logical formula, time step logical formula which is a logical formula representing a state for each time step for executing a certain objective task which is a task for each robot to work,
wherein the processor generates the control input based on the abstract model and the time step logical formula.

9. The control device according to claim 8, wherein the processor generates the including a logical sum of a logical formula corresponding the objective task and an environment evaluation value in which accuracy represented by the environment map is evaluated

10. The control device according to claim 1, wherein the processor is further configured to supply a subtask sequence in which the control input is converted into a sequence of subtasks executable for each robot, to a corresponding robot.

11. The control device according to claim 1, wherein the processor updates the environment map to attenuate the accuracy in a space based on the passage of time after the measurement in the space where the measurement has performed.

12. A control method comprising:
setting an abstract state which abstractly represents a state of each object in a workspace where each robot works;
generating an environment map which is a map representing accuracy of information in the workspace;
generating an abstract model which represents dynamics of the abstract state and a time change of the environment map; and
generating a control input with respect to each robot based on the abstract model.

13. A non-transitory computer-readable recording medium storing a program, the program causing a computer to perform a process comprising:
setting an abstract state which abstractly represents a state of each object in a workspace where each robot works;
generating an environment map which is a map representing accuracy of information in the workspace;
generating an abstract model which represents dynamics of the abstract state and a time change of the environment map; and
generating a control input with respect to each robot based on the abstract model.
